(19) United States
(12) Patent Application Publication
(10) Pub. No.: US 2007/0084763 A1
(43) Pub. Date: Apr. 19, 2007

(54) Foreign matter detection system and method

(76) Inventors: Michael B. Stephenson, Plainfield, IL (US); Alexander G. Nowak, Geneva, IL (US); James H. Snow, Lake in the Hills, IL (US)

Correspondence Address: Baker & Daniels;St. 700, 805 15th Street, N.W., Washington, DC, 20005, US

(21) Appl. No.: 11/582,554

(22) Filed: Oct. 18, 2006

Related U.S. Application Data
(60) Provisional application No. 60/727,508, filed on Oct. 18, 2005.

(51) Int. Cl. B07C 5/00

(52) U.S. Cl. 209/577

(57) ABSTRACT

Embodiments of the present invention are directed to a method and system for detecting foreign matter in a container, and in particular to the detection of foreign matter during bottle processing operations. The detection system may include an optically clear container support for supporting the container and a light source for illuminating the container. The container may additionally include an imaging device disposed on an opposite side of the optically clear support from the container, wherein the imaging device captures an image of the illuminated container and container contents through the optically clear support in order to detect foreign matter in the container contents.

### PRIORITY DATA

The present application claims priority to U.S. Provisional Patent Application Ser. No. 60/727,508, filed on Oct. 18, 2005.

### TECHNICAL FIELD

Embodiments of the present invention relate to a foreign matter detection technique and more particularly to a technique for detecting foreign matter in filled containers during processing.

### BACKGROUND OF THE INVENTION

Manufacturers that package consumable products typically utilize high speed manufacturing equipment to process packaging. For example, bottled water line processing may process as many as twelve hundred bottles per minute. Often the packages are prepared for mass distribution around the country and globally as well.

These highly mechanized manufacturing lines and filling machines have the propensity to drop parts such as, bolts, nuts, springs, cotter pins, and similar hardware into open bottles. These parts can come loose as the production line runs over time.

Particularly with regard to bottling processing operations, the bottles move at high speeds over long distances without a cap prior to filling at the filling machine. This provides many opportunities for loose parts to drop into the bottle. If a bottle containing foreign matter is shipped to a customer, a liability issue is eminent.

Typically, bottling plants incorporate inspection systems for detecting various unacceptable conditions including the presence of foreign matter in containers. The foreign matter may include bacterial contamination stemming from inept packaging or seal integrity, metallic foreign body contamination (i.e. nuts, bolts, washers) from the processing line itself, glass or plastic shards or chips from the packaging, and sabotage involving the intentional placement of hazardous items such as syringes and glass bodies within containers.

Previously, inspection processes have been accomplished manually by positioning an inspector to visually detect foreign matter. Other more automated techniques have been implemented for visual inspection, but often are implemented prior to labeling of the bottles because the label, once affixed, obstructs the view of the container and its contents. Thus, in these inspection processes implemented prior to labeling, foreign matter may be introduced into the container after inspection, and thus go undetected. Other solutions have implemented a three or four camera side view approach. However, because foreign matter is often deposited on a container base, it is difficult for side view cameras to accurately see foreign matter.

In order to meet quality control standards and avoid product liability claims and the increased financial penalties that accompany them, a solution is needed for detecting foreign matter in real time during container processing.

### BRIEF SUMMARY OF THE INVENTION

In one aspect, a system is provided foreign matter detection. The system detects foreign matter in a container and includes an optically clear container support for supporting the container. The system additionally includes a light source for illuminating the container and an imaging device disposed on an opposite side of the optically clear support from the container. The imaging device captures an image of the illuminated container and container contents through the optically clear support in order to detect foreign matter in the container

In a further aspect of the invention, a system may be provided for detecting foreign matter in a container during container processing. The system may include an illumination source for illuminating the container from a first end and a camera for capturing an image of the container from a second end, the second end disposed on an opposite end of the container from the first end. The system may additionally include a controller including an inspection program module for receiving and analyzing the captured image to determine if foreign matter is present in the container.

In yet a further aspect of the invention, a method may be provided for detecting foreign matter deposited in a container during processing. The method may include supporting the container with an optically clear container support; illuminating the container with an illumination source; and capturing an image of the container and container contents with a camera positioned on an opposite side of the optically clear container support from the illumination source.

### BRIEF DESCRIPTION OF THE DRAWINGS

The above-mentioned and other features of this invention, and the manner of attaining them, will become more apparent and the invention itself will be better understood by reference to the following description of embodiments of the invention taken in conjunction with the accompanying drawings, wherein:

FIG. 1 is a block diagram illustrating components of a foreign matter detection system in accordance with an embodiment of the invention;

FIG. 2 is a front elevation of a foreign matter detection assembly in accordance with an embodiment of the invention;

FIG. 3 is top view of a foreign matter detection assembly incorporated in a labeling system in accordance with an embodiment of the invention;

FIG. 4 is a perspective view of a foreign matter detection system in accordance with an embodiment of the invention;

FIG. 5 is a perspective view of a support component of the foreign matter detection system in accordance with an embodiment of the invention;

FIG. 6 illustrates a captured image corresponding to the support conditions of FIG. 5 in accordance with an embodiment of the invention;

FIG. 7 is a captured image illustrating a contamination image in accordance with an embodiment of the invention;

FIG. 8 is a gray scale image showing the contamination sample of FIG. 7;

FIG. 9 is a captured image of another contamination sample in accordance with an embodiment of the invention;

FIG. 10 is a captured image showing no contamination; and

FIG. 11 is a flowchart illustrating a method for bottle inspection in accordance with an embodiment of the invention.

### DETAILED DESCRIPTION OF PREFERRED EMBODIMENTS

Embodiments of the present invention are directed to a foreign matter detection system and method and in particular to a system and method for detecting foreign matter in bottles or other containers during assembly line processing.

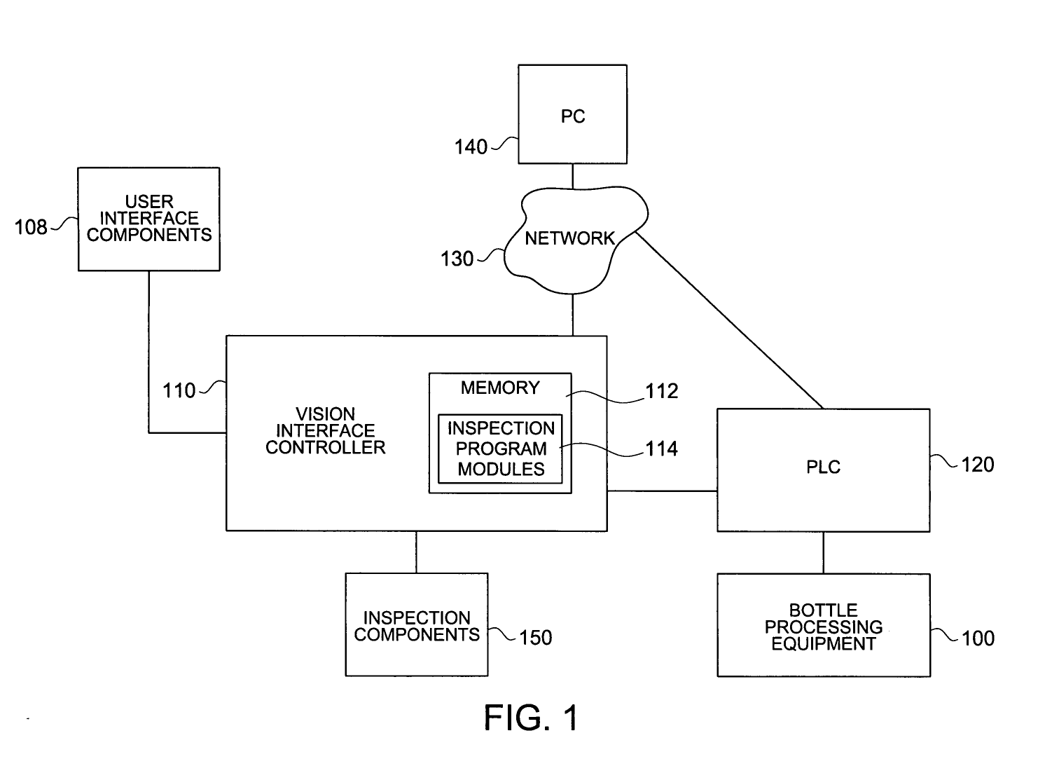

FIG. 1 is a block diagram illustrating components of a foreign matter detection system in accordance with an embodiment of the invention. The system may be built around a vision system controller 110 that includes a memory 112 including inspection program modules 114. The vision system controller controls inspection components 150. As will be further described below, the inspection components 150 may include a high speed camera that operates in conjunction with a light source and a photo-eye trigger. The vision system controller 110 can be accessed through user interface components 108 that may include one or more user interfaces such as a monitor, a touch screen, a console, a keyboard, and other devices. The vision system controller 110 may be connected over a network 130 with a personal computer 140, which may optionally be disposed at a remote location.

The inspection components 150 including the camera may be located adjacent bottle or container processing equipment 100. An illumination source and a photo-eye trigger may be connected with the bottle processing equipment 100 and controller 110.

The vision system controller 110 may include one or more CPUs for processing programmable components contained in a memory card or extendable memory. The vision system controller 110 may further include a power supply unit, I/O control module, I/O connecting cables, programming console, and programming software. The controller 110 may also include various communication interfaces including serial interfaces, USB interfaces, and parallel interfaces. The vision system controller 110 may also include a memory card interface and furthermore an interface for connecting with each component shown in FIG. 1. Preferably, the vision system controller is a small sized module that provides high speed communication, such as Omron's F210-ETN series vision controller.

The provided vision system controller 110 enables access to production data, operating status, and images via Ethernet to configure a production and quality control system that delivers real time data and operation critical results. The system may incorporate a camera such as a high speed 250,000 pixel digital camera. Uninterrupted vision inspection and data collection may be provided with a separate parallel processor for measurement functions and communications. The system allows viewing of real time video images, measurement values and judgment results from the PC 140, which may be located remotely. The digital camera interface of the vision system controller 110 should be provided to deliver clear images and reduce noise in the video signal that can obscure measuring accuracy. Furthermore, if more than one camera is provided, the vision system controller 110 may be capable of coordinated multiple camera inspections. In controllers such as Omron's F210-ETN, built in measurement tools include pre-programmed algorithms that reduce start up time.

The vision system controller 110 preferably can execute measurement and storage functions independently. The images can be displayed on the PC 140 in real time using Ethernet capabilities of the vision system controller 110. Thus, it is possible to monitor live inspection images from a remote location. Furthermore, in embodiments of the invention, images from multiple vision system controllers connected over a network can be viewed simultaneously. Data stored in the controllers can be transferred to a personal computer such as PC 140 at any time, thus allowing analysis of data without slowing down production. Operations such as stopping inspection, setting or changing scene data and collecting files saved on the vision system controller 110 can all be done from a personal computer 140 in another part of the manufacturing plant or in a distant location.

Inspection program modules 114 may operate to respond to a sensor such as a photo-eye trigger to activate image capture by the camera. The inspection program modules 114 then analyze the captured image to determine if it contains foreign matter. In embodiments of the invention, the captured image may be compared to an uncontaminated image. The system may be calibrated by determining the minimum sized object that needs to be identified. This object can be placed in a bottle and the system can be adjusted so that the image of the object is visible. Furthermore, optimal inspection conditions may be based on accumulated measurement values and images. Each captured image may be independently analyzed for the presence of foreign objects by various available techniques known in the art.

An additional Programmable Logic Controller (PLC) 120 may be provided for controlling bottle processing equipment 100. The PLC 120 may contain components similar to those described above with respect to the vision system controller 110. Alternatively, a single controller may control bottle processing and inspection operations or additional controllers may be provided to control various bottle processing and inspection functions.

The vision system controller 110, upon analyzing a captured image, may send feedback to the PLC 120 that controls the bottle processing equipment 100. The feedback may be in the form of “good” for an uncontaminated sample or “no good” for a contaminated sample. The PLC 120 may react by appropriately controlling the bottle processing equipment to discharge contaminated bottles through a designated route, such as by dropping them in a bin adjacent the inspection station or further down the processing line.

The bottle processing equipment 100 may include labeling equipment and inspection may be performed upon completion of labeling. Suitable labeling equipment for this application is produced by Krones Incorporated.

The personal computing device 140 may optionally be included in the system in order to provide additional system control, supervision, and programming capabilities. If the personal computing device 140 is included, it may comprise one or multiple distributed computing devices. The personal computing device 140 would typically include a processing unit, a memory, a peripheral interface, a removable memory interface, a network interface, and a user input interface. A system bus may be used to couple the aforementioned components.

The personal computing system memory may include computer storage media in the form of volatile and/or nonvolatile memory such as read only memory (ROM) and random access memory (RAM) A basic input/output system (BIOS), containing the basic routines that help to transfer information between elements, such as during start-up, is typically stored in ROM. RAM typically contains data and/or program modules that are immediately accessible to and/or presently being operated on by processing unit.

The RAM may include an operating system and program data. Application programs stored in RAM may be described in the general context of computer-executable instructions, such as program modules, being executed by a computer. Generally, program modules include routines, programs, objects, components, data structures, etc. that perform particular tasks or implement particular abstract data types.

The personal computing system may also include other removable/non-removable, and volatile/nonvolatile computer storage media. A hard disk drive may be provided that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

A user may enter commands and information through the user input interface using input devices such as a keyboard and pointing device, commonly referred to as a mouse, trackball or touch pad. Other input devices may include a microphone, satellite dish, scanner, or the like. These and other input devices are often connected to the processing unit through the user input interface that is coupled to the system bus, but may be connected by other interface and bus structures, such as a parallel port or a universal serial bus (USB). A monitor or other type of display device and other peripherals may also be connected to the system bus via an interface, such as the peripheral interface.

The personal computing system in embodiments of the present invention may operate in a networked environment over the network using logical connections to communicate with networked components. Logical connections for networking may include a local area network (LAN) or a wide area network (WAN), but may also include other networks. Other components shown in FIG. 1 may operate in a similar computerized environment.

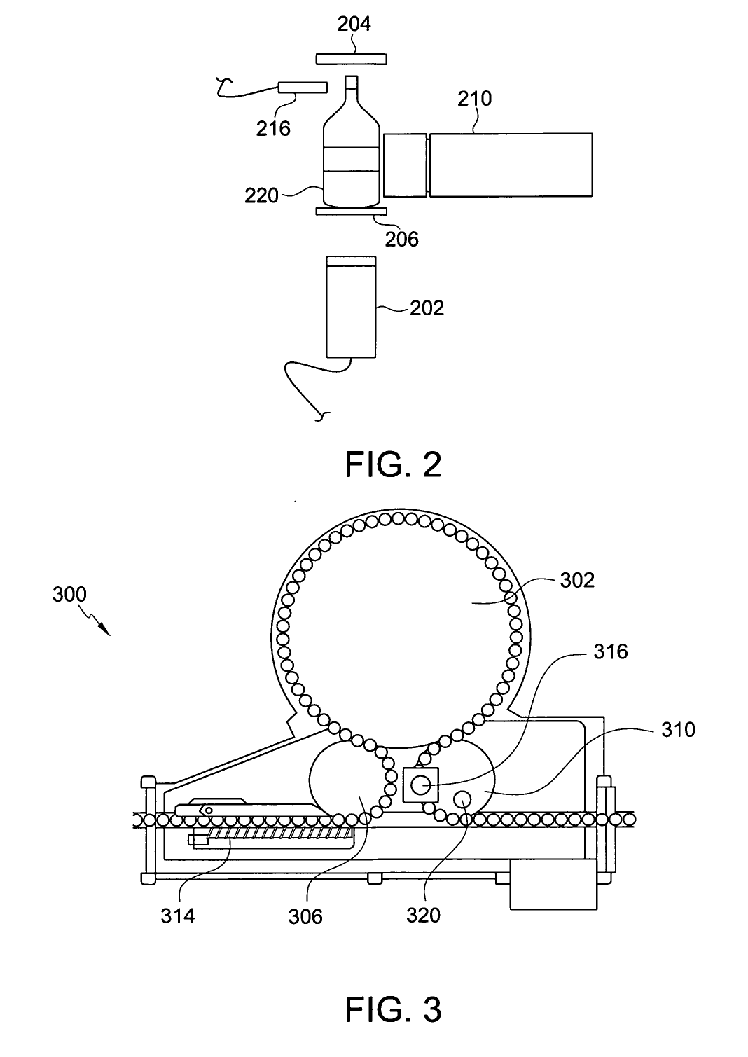

FIG. 2 is a front elevation of interacting components of the bottle processing equipment and the foreign matter detection system in accordance with an embodiment of the invention. In the illustrated embodiment, a light source 204 is disposed above a bottle 220 and a photo-eye trigger 216 is disposed proximal to the light source 204 and the bottle 220. The bottle 220 is supported by an optically clear support 206. A camera 202 may be located below the support 206 and may be mounted to face a bottom portion of the bottle 220. Bottle processing component 210 may include a wheel and gripper or other components may be used to manipulate the bottle 220. As long as contents of the bottle 220 will pass light, foreign objects can be detected provided that those foreign objects are light blocking.

Support 206 may made from a borosilicate glass, such as Borofloat™, which is manufactured by Schott Corporation. The glass is highly chemically resistant with low thermal expansion. It also has a mirror like surface quality, high thermal resistance and excellent transmission, making it suitable for manufacturing applications. Borofloat glass has a refractive index of 1.571, and a material composition of 81% SiO₂, 13% B₂O₃, 4% Na₂O/K₂O, and 2% Al₂O₃. Alternative transparent materials, such as Pyrex, polycarbonate, or various types of glasses or plastics may be implemented in accordance with embodiments of the invention.

The camera 202 may be a digital camera, such as Omron Corporation's F210-S1. The camera may implement high precision lenses to capture a real time image. In embodiments of the invention, more than one camera may be controlled by the vision system controller 110 and implemented for inspection purposes. Digital interface cameras such as Omron's F210-S1 or F500-S1 may be implemented in embodiments of the invention. The F210-S1 may be implemented in conjunction with lenses such as the F150-L16 and the F150-L25. The F500-S1 may be implemented in conjunction with Omron's high precision lenses such as the F500-LE16 or the F500-LE25.

The illumination source 204 may comprise a long lasting LED light source. One suitable illumination source is the Spectrum Illumination 1.25-630. This is a spotlight having a compact size and a 1.25″ light emitting window. It is a high output LED that includes highly efficient optics that provide tight collimated light. The Spectrum Illumination 1.25-630 is produced in seven colors and white. The wavelength range of this light source, depending upon color can be from 439 nm to 646 nm.

The photo-eye trigger 216 detects glare of the illumination source. When a container, such as the bottle 220, passes in front of the illumination source 204, the photo-eye trigger 216 registers the presence of a the container and sends a signal to the vision system controller 110 for image capture. The photo-eye trigger 216 could be any type of photo-eye trigger 216 that detects quality of reflection or glare, or the presence of clear objects. The use of the trigger sensor facilitates tracking of images associated with each container.

The bottle 220 may be any type of container that allows light to pass, which will generally be a transparent material. The process may in some instances operate on translucent materials that allow light to pass through them diffusely. In this instance the material may blur the image and additional analysis and calibration may be required.

FIG. 3 is a top view of bottle processing equipment implemented in conjunction with the foreign matter detection system. An in-feed worm 314 may cause containers such as bottles to be fed to an in-feed star wheel 306. From the in-feed star wheel 306, bottles may be transported to a container table 302. A discharge star wheel 310 discharges bottles from the container table. A light or illumination source 316 may be mounted above the out-feed area or discharge star wheel 310 in order to distribute light through the cap and top walls of the bottle. An air knife or blower 320 may be implemented to remove water droplets from the process and clean container bases which may accumulate foam and lubricant residues. The design of the foreign matter detection system may include replacing the standard support on the labeler, which is typically a piece of UHMW plastic, with an optically clear piece of borosilicate.

Servomotors (not shown) rotate the container tables and bottles and may stop them again for container inspection. Containers may also be transferred to a separate inspection star wheel.

The processing equipment may be controlled at a central operating terminal that may include a touch screen. Individual components of the labeling stations may in some instances be separately controlled. A menu may be available for guiding the user. The central operating terminal may provided access to all camera images taken during processing.

The illustrated labeler shows a linear arrangement such that bottles enter the process and are discharged from the process along the same processing line. However the configuration may easily be altered to most efficiently utilize space. For example, the labeler may be set up in a parallel arrangement such that containers are discharged along a parallel processing track or alternatively and angular arrangement, such that the discharge processing line forms an angle with the inlet processing line.

The camera (not shown in this view) may be placed below the bottom support plate and may face the bottom of the bottle. The labeling machine lends the ability to view containers from the bottom while lighting them from the top with the illumination source 316. At the same time, the bottles may be captured in an index wheel. Particles in the bottom of the bottle block the light 316 from the camera thereby causing an alarm condition. The alarm condition may cause a signal to be sent from the vision controller 110 to the PLC 120 so that it may identify the bottle as rejected.

The processing equipment may incorporate a Krones modular labeling machine. The labeling equipment may include several of the same type or different labeling stations. The individual labeling stations are engaged at the machine support and each has a separate drive which is electronically connected with the main drive. The container plate at the container table is driven by a computer controlled servo drive. Bottle rotations necessary for label roll-on are carried out according to a PLC program. Thus, cold glue and hot glue labeling as well as the execution of self adhesive labels may be executed on one container table. The processing equipment can easily be altered to accommodate varying container and label sizes. Faulty containers can be rejected at machine discharge via a retaining star wheel, clamping star wheel, or pusher. In embodiments of the invention, rejected containers may be discharged to a separate processing lane or to multiple separate processing lanes.

Thus in order to be implemented with the invention described herein, a labeler, such as the Krones labeler, requires modification. One modification involves replacing the support, typically a UHMW “dead plate”, with an optically clear plate at the star wheel located downstream from labeling operations. Further modifications include adding an air blast to remove standing water and/or debris and installing the enclosed camera below the machine.

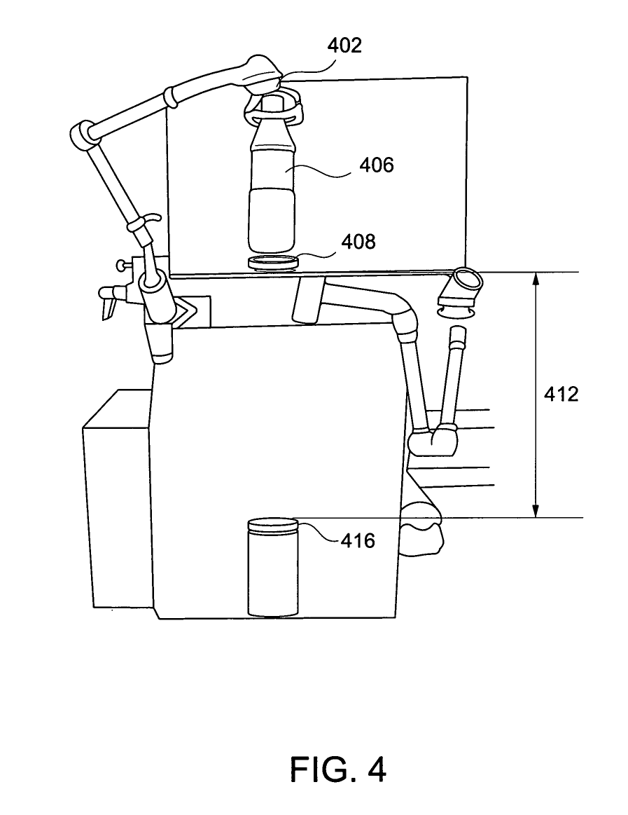

FIG. 4 is a perspective view illustrating a foreign matter detection system in accordance with one preferred embodiment of the invention. A light source 402 is mounted above a bottle 406. In the illustrated embodiment, the light source 402 may a spectrum illumination SP1.25-630 light source. The light source 402 may be positioned approximately one half inch from a cap of the bottle 406. In the illustrated embodiment, the bottle 406 is a half liter bottle. A support 408 may be provided for supporting the bottle 406. A camera 416 may include a lens such as 25 mm lens spaced from the support 408. The support 408 may in this embodiment be a ¾ inch polycarbonate support. The camera lens 416 may be positioned a distance 412 below the support 408. In embodiments of the invention, the distance 412 may be approximately sixteen inches.

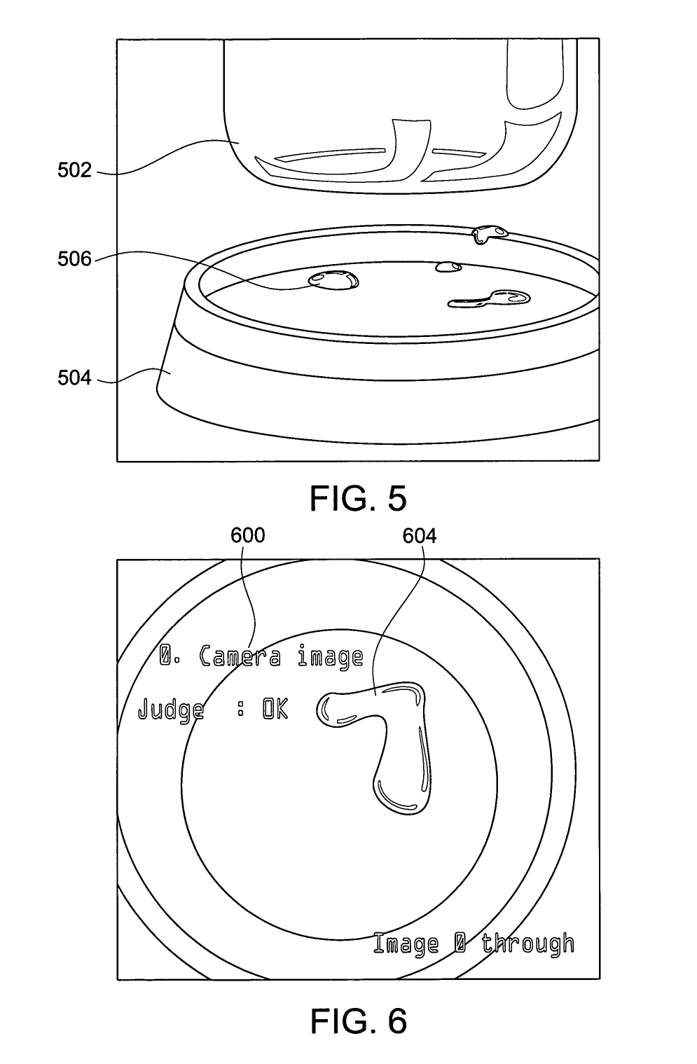

FIG. 5 is a perspective view illustrating a support 504 and bottle 502. Water droplets 506 may periodically form on the support 504. FIG. 6 illustrates an image 600 captured by the camera in which a water droplet 604 obstructs the image.

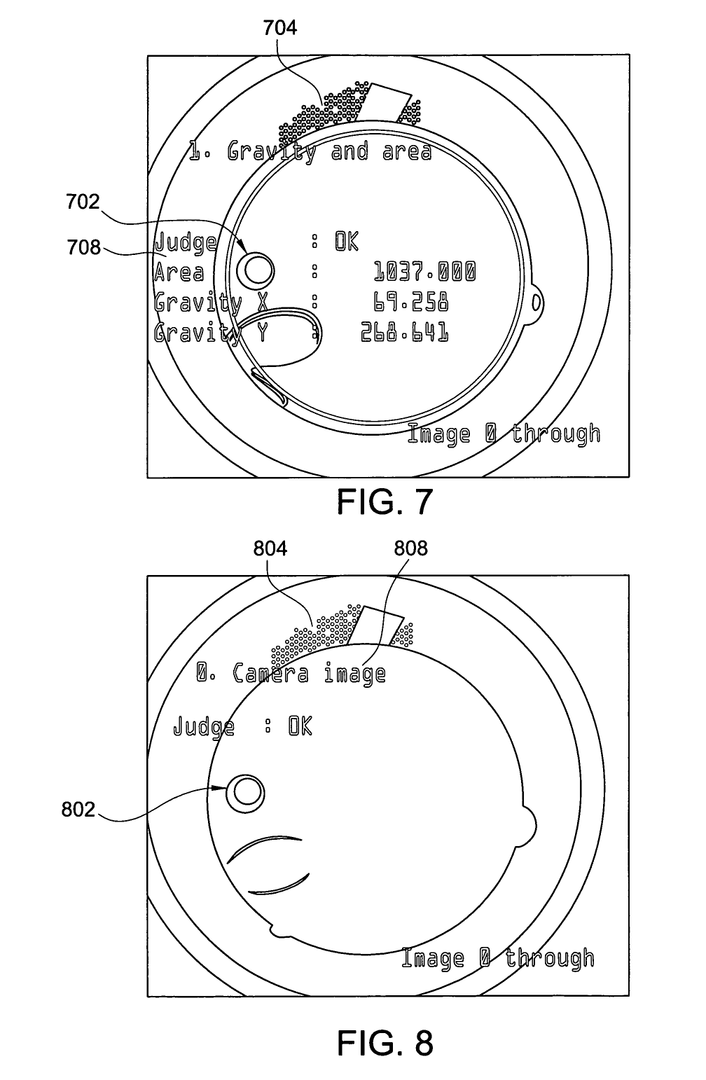

FIG. 7 illustrates a small nut sample and FIG. 8 illustrates a gray scale version of the same image. As shown at 702 and 802, the small nut sample image was erased by dissipation of the image through a water droplet. As shown at 704 and 804, scratches minimally impacted inspection and water droplets adversely increased pixel count depending upon edge illumination. Information 708 and 808 may accompany the image.

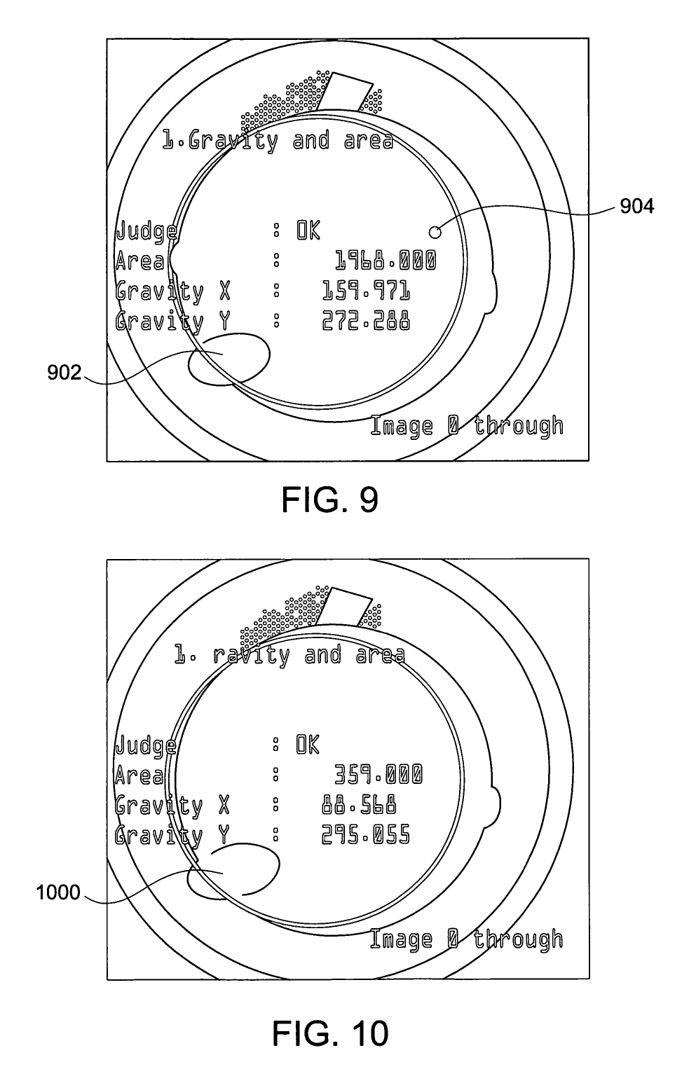

FIG. 9 illustrates an image 902 showing a pin 904 disposed in the bottle. FIG. 10 illustrates an image 1000 with no contamination. An image such as that shown in FIG. 10 may be stored as a registered model and compared to captured images to reveal fine defects. As set forth above, in operation, an air knife may be used to eliminate water droplets on the optically clear surface. The lens may be used to eliminate shadows off a side wall of the bottle.

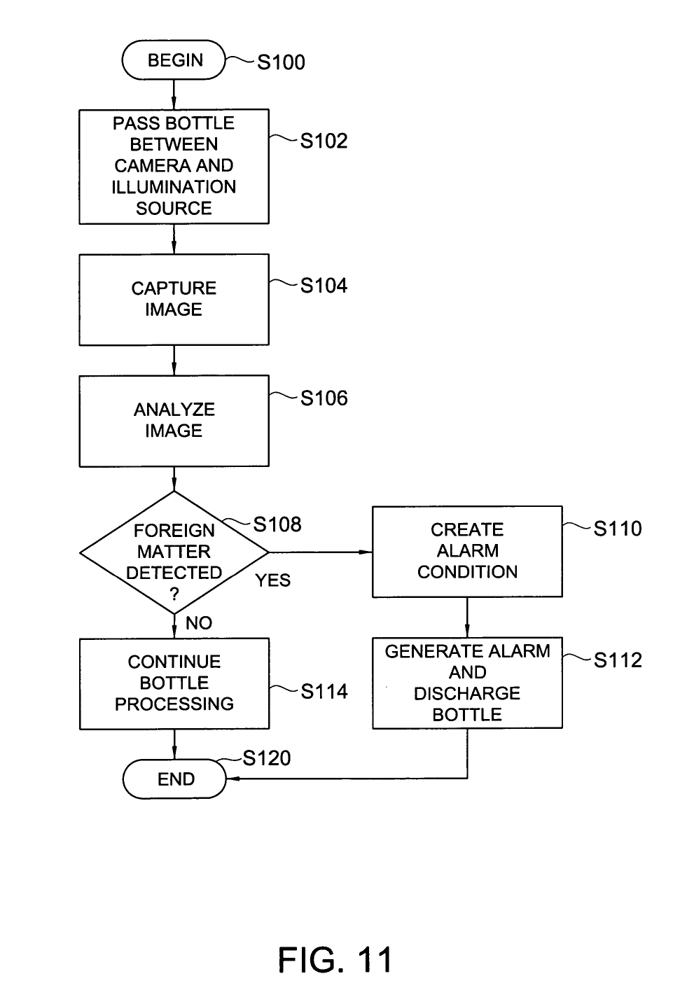

FIG. 11 is a flowchart illustrating an inspection process in accordance with an embodiment of the invention. The process begins in S100 and the container is passed between the camera and illumination source in S102. In S104, the camera captures an image of the container. The image capture may occur in response to a sensor or photo-eye trigger alert occurring simultaneously with the passage of the container between the camera and the illumination source. In S106, the inspection program module analyzes the image. In S108, the analysis reveals whether foreign matter has been detected. If foreign matter is not detected in S108, the system continues bottle processing in S114 and processing is completed in S120. If foreign matter is detected in the bottle in S108, an alarm condition is created in S110 and an alarm is generated and the bottle is discharged in S112. Optionally, when the alarm is generated, the container is discharged as a flawed container using one of the methods described above.

The analysis of S104 may include comparing the captured image to a stored model image such as the image shown in FIG. 110. Detected items include bolts, washers, or other items that might fall from machines. As set forth above, the system may implement standard or high speed vision cameras. The vision system controller has enough memory to grab image and compare it to a reference point.

The system greatly reduces the likelihood of a container of liquid containing foreign matter being shipped to a distribution plant. The system operates efficiently and economically. The solution may be applied to multiple types of containers including glass and plastic bottles. Once the containers leave the filling machine they can be inspected for foreign matter by lighting the container and its contents from the top and capturing an image from the bottom.

As set forth above, In one preferred embodiment, the foreign matter detection system may be built around the F210-ETN Vision Controller. The F210-ETN is a stand-alone, industrial unit that has the capacity to accommodate up to two cameras. The F210-ETN has Ethernet capabilities that provide the ability to transfer either the “Good” or the “No Good” Images acquired and/or the inspection data. The vision controller includes vision programming and data transfer software. The inspection program can be transferred from one system to another, one plant to another or stored. There is no need to program every system.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A foreign matter detection system for detecting foreign matter in a container, the detection system comprising:
an optically clear container support for supporting the container;
a light source for illuminating the container; and
an imaging device disposed on an opposite side of the optically clear container support from the container, wherein the imaging device captures an image of the illuminated container and container contents through the optically clear container support in order to detect foreign matter in the container contents.

2. The system of claim 1, wherein the optically clear container support comprises a borosilicate glass support.

3. The system of claim 1, wherein the imaging device, the optically clear container support, and the light source operate in conjunction with a container labeler.

4. The system of claim 3, further comprising a photo-eye trigger for initiating image capture.

5. The system of claim 3, further comprising a mechanism for removing water droplets from the optically clear container support.

6. The system of claim 3, further comprising an inspection programming module for analyzing a captured image for detection of foreign matter.

7. The system of claim 6, further comprising a discharge mechanism for separately discharging a container upon detection of foreign matter in a container image.

8. The system of claim 3, wherein the imaging device captures an image of sealed container, such that inspection is performed after sealing.

9. The system of claim 1, wherein the light source comprises an LED producing collimated light.

10. A system for detecting foreign matter in a container during container processing, the system comprising:
a light source for illuminating the container from a first end:
a camera for capturing an image of the container from a second end, the second end disposed on an opposite end of the container from the first end; and
a controller including an inspection program module for receiving and analyzing the captured image to determine if foreign matter is present in the container.

11. The system of claim 10, further comprising an optically clear container support for supporting the container.

12. The system of claim 11, wherein the optically clear container support is disposed between the camera and the container, such that the camera captures an image of the illuminated container and container contents through the optically clear support in order to detect foreign matter in the container contents.

13. The system of claim 12, wherein the optically clear container support comprises a borosilicate glass support.

14. The system of claim 12, wherein the camera, the optically clear container support, and the light source operate in conjunction with a container labeler.

15. The system of claim 14, further comprising a photo-eye trigger for initiating image capture.

16. The system of claim 14, further comprising a mechanism for removing water droplets from the optically clear container support.

17. The system of claim 14, further comprising a discharge mechanism for separately discharging a container upon detection of foreign matter in a container image.

18. The system of claim 14, wherein the camera captures an image of sealed container, such that inspection is performed after sealing.

19. The system of claim 10, wherein the light source comprises an LED producing collimated light.

20. A method for detecting foreign matter in a container during container processing, the method comprising:
supporting the container with an optically clear container support;
illuminating the container with a light source; and
capturing an image of the container and container contents with a camera positioned on an opposite side of the optically clear container support from the illumination source.

21. The method of claim 20, further comprising analyzing the captured image using an inspection program module to detect foreign matter presence.

22. The method of claim 20, further comprising performing the detection method during container processing after the container has been sealed.

23. The method of claim 20, further comprising incorporating the camera, the optically clear container support, and the light source in a container labeling machine.

24. The method of claim 23, further comprising incorporating a photo-eye trigger for initiating image capture.

25. The method of claim 23, further comprising providing a mechanism for removing water droplets from the optically clear container support.

26. The method of claim 23, further comprising providing a discharge mechanism for separately discharging a container upon detection of foreign matter in a container image.

27. The method of claim 20, further comprising providing an LED light source producing collimated light.

28. The method of claim 21, further comprising generating an alarm upon detection of foreign matter in a container.

29. The method of claim 21, further comprising calibrating the analysis by capturing an image of a smallest foreign matter sample for detection and ensuring the sample is detectable by the analysis.
